(19) United States
(12) Patent Application Publication
(10) Pub. No.: US 2005/0172760 A1
(43) Pub. Date: Aug. 11, 2005

(54) Adjustable screwdriver

(75) Inventor: Nathan C. Cantlon, Charlo, MT (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Jore Corporation, Pasco, WA (US)

(21) Appl. No.: 11/008,560

(22) Filed: Dec. 8, 2004

Related U.S. Application Data
(60) Provisional application No. 60/528,805, filed on Dec. 11, 2003.

(51) Int. Cl. B25B 23/04

(52) U.S. Cl. 81/438

(57) ABSTRACT

The present invention provides a screwdriver comprising: (a) a handle; (b) a connector that is at least partially located within the handle; and (c) a screwdriver bar comprising a bar body that defines a multiplicity of indentations, wherein in operation the connector releasably engages at least one of the indentations to secure the bar within the connector.

### CROSS-REFERENCE TO RELATED APPLICATION

This application claims the benefit of U.S. Provisional Application No. 60/528,805, filed on Dec. 11, 2003.

### FIELD OF THE INVENTION

The present application relates to adjustable screwdrivers having an indented screwdriver bar.

### BACKGROUND OF THE INVENTION

A repair or construction project may require the use of several screwdrivers having different lengths and having different types of screwdriver heads (e.g., a Phillips head or a square head or a slotted head). Screwdriver kits are available that provide several screwdrivers having different lengths and head geometries. These kits are cumbersome, however, because of the number of different screwdrivers present in the kit, and a single task may require the use of several different screwdrivers. Alternatively, screwdriver kits are available that provide a single screwdriver handle that releasably engages a variety of different screwdriver bars having different lengths and head geometries. Typically, these screwdriver handles include a bulky connector that functions to engage the various screwdriver bars. The bulky connector physically limits the utility of these screwdrivers in confined workspaces (e.g., a deep, narrow workspace).

In order to solve this problem, the present invention provides screwdrivers that are adapted to permit a user to selectably release and extend, or retract, a screwdriving bar to any one of a number of predetermined positions. The screwdriving bar can include any combination of screwdriving tip configurations at one or both ends of the bar. A customer is therefore provided with a single, compact tool that has the versatility to fit different screw heads in different workspaces.

### SUMMARY OF THE INVENTION

In one aspect the present invention provides a screwdriver comprising: (a) a handle; (b) a connector that is at least partially located within the handle; and (c) a screwdriver bar comprising a bar body that defines a multiplicity of indentations, wherein in operation the connector releasably engages at least one of the indentations to secure the bar within the connector. At least some of the indentations are spaced along the length of the screwdriver bar so that the connector can engage the screwdriver bar at different positions along its length, thereby providing a user with the option of adjusting the length of the portion of the screwdriver bar extending out of the screwdriver handle.

Some embodiments of the screwdrivers of the present invention comprise: (a) a handle defining a cavity; (b) a connector that is at least partially located within the handle, wherein the connector comprises: (1) a connector body that defines a central cavity, a first passage that completely penetrates the connector body, and a second passage that completely penetrates the connector body; (2) a first retaining member disposed within the first passage; (3) a second retaining member disposed within the second passage; (4) a retaining spring disposed within a groove that extends around the connector body; (5) a tensioning spring disposed around the connector body; (6) a collar slidably disposed around the connector body, the retaining spring and the tensioning spring; and (c) a screwdriver bar, defining a multiplicity of indentations, having a first end and a second end, wherein the second end is disposed within the screwdriver handle. In operation, the tensioning spring biases the collar against the retaining spring and against the first and second retaining members that engage at least one indentation in the screwdriver bar body, thereby securing the screwdriver bar within the screwdriver.

The screwdrivers of the invention can be used to introduce and/or remove screws from a substrate. It is an advantage of the screwdrivers of the present invention that the length of the screwdriver bar protruding from the connector can be varied by engaging different indentations located at different positions along the length of the screwdriver bar. The screwdriving bar can include any combination of screwdriving tip configurations incorporated to one or both ends of the bar. For example, both ends of the bar can bear a Philips screwdriver head, or one end of the bar can bear a slotted screwdriver head and the other end of the bar can bear a Phillips screwdriver head.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a side view of a screwdriver of the present invention.

FIG. 2 shows an exploded view of the screwdriver of FIG. 1.

FIG. 3 shows a longitudinal cross-section of the screwdriver handle, and connector body, of the screwdriver of FIG. 1, showing the cavities therein.

FIG. 4 shows a longitudinal cross section of a connector collar mounted on a connector.

FIG. 5 shows a longitudinal cross-section of a connector in the locked configuration.

FIG. 6 shows a longitudinal cross-section of a connector in the unlocked configuration.

FIG. 7 shows an embodiment of the screwdriver of FIG. 1 wherein the screwdriver bar protrudes further from the handle than the screwdriver bar shown in FIG. 1.

### DETAILED DESCRIPTION OF THE PREFERRED EMBODIMENT

In one aspect the present invention provides screwdrivers that each include: (a) a handle; (b) a connector that is at least partially located within the handle; and (c) a screwdriver bar comprising a bar body that defines a multiplicity of indentations. In operation the connector releasably engages at least one of the indentations to secure the bar within the connector.

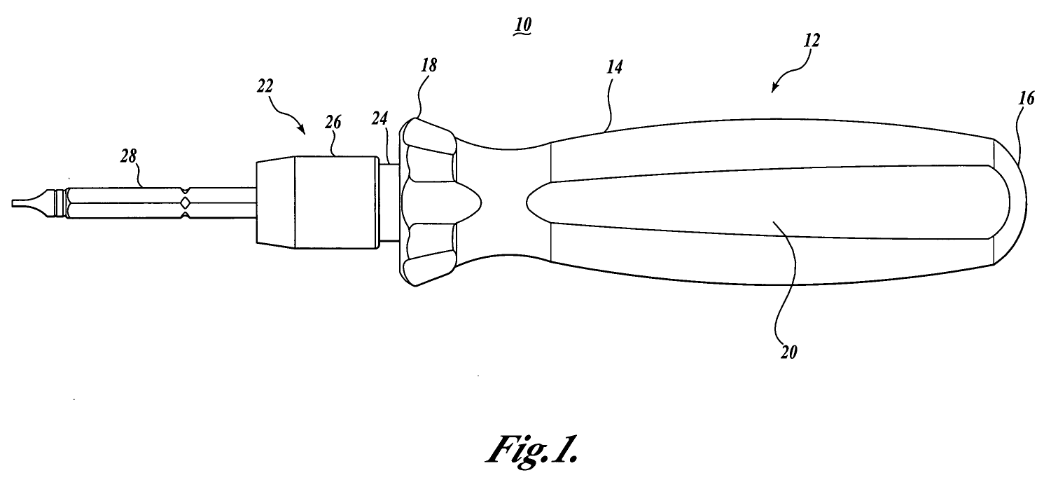

FIG. 1 shows a side view of a screwdriver 10 of the present invention. Screwdriver 10 includes a handle 12 comprising a handle body 14, a handle first end 16 and a handle second end 18. Handle body 14 defines a handle surface 20 that is contoured to facilitate gripping by a user. Screwdriver 10 also includes a connector 22 that includes a spacer 24 and a collar 26. A screwdriver bar 28 is releasably engaged by connector 22.

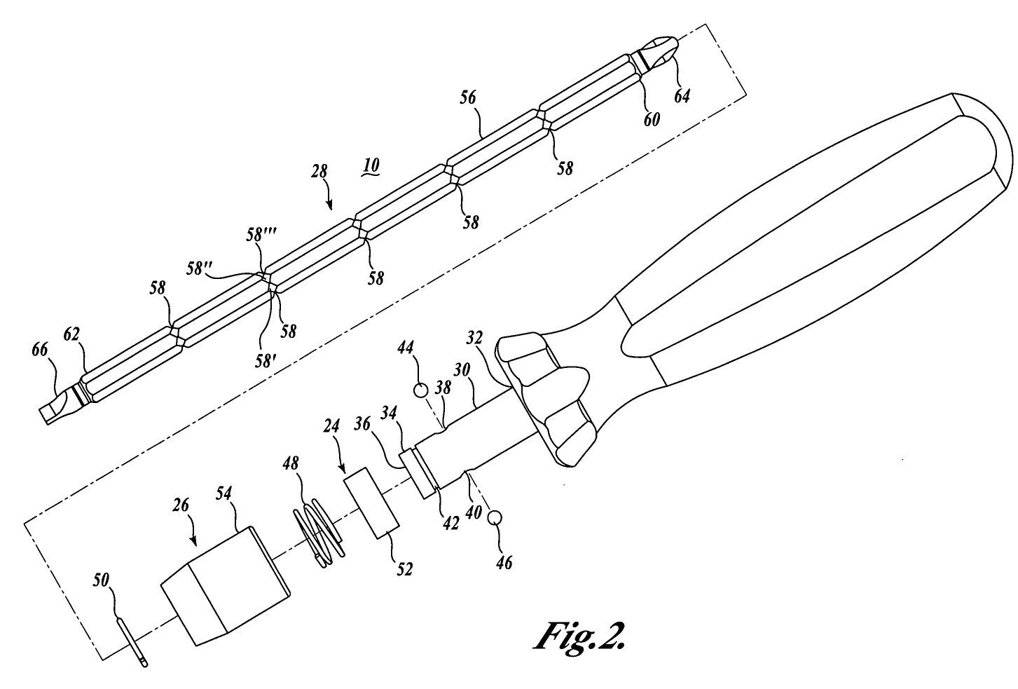

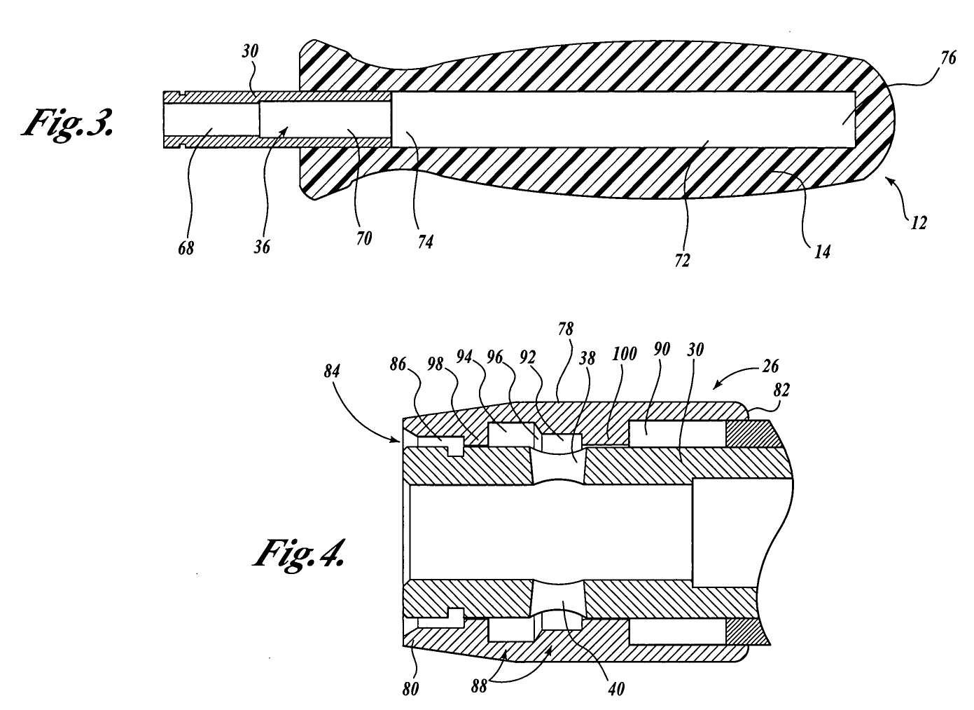

FIG. 2 shows an exploded view of screwdriver 10. Screwdriver 10 includes a connector body 30 having a connector body first end 32 and a connector body second end 34. Connector body 30 defines a cavity 36, a first passage 38, and a second passage 40. Cavity 36, first passage 38, and second passage 40 are shown more clearly in FIG. 3. A groove 42 extends around connector body 30. Connector 22 includes a first locking member 44 and a second locking member 46. Locking members 44 and 46 are steel ball bearings in the embodiment of screwdriver 10 shown in FIG. 2, but can also be, for example, cylindrical pins having rounded ends. Connector 22 also includes a tensioning spring 48 and a retaining spring 50. Spacer 24 includes a spacer body 52 that is hollow. Connector collar 26 includes a hollow connector body 54.

Screwdriver bar 28 includes a bar body 56 that defines groups (e.g., 2, 3, 4, 5, 6, 7, 8, 9, or 10 groups) of multiple indentations 58 (e.g., a group composed of 2, 3, 4, 5, 6, 7, 8, 9, or 10 indentations 58) that are spaced at different positions along the length of bar body 56. Indentations 58 of each group of indentations 58 are arranged around the circumference of bar 28 at the same position along the length of bar 28 (e.g., indentations 58′, 58″ and 58′″ shown in FIG. 2). Thus, as described more fully herein, locking members 44 and 46 can each engage a separate indentation 58, within a group of indentations 58, at the same position along the length of bar 28, thereby securing bar 28 within screwdriver 10. Indentations 58 can have any configuration that is capable of receiving a portion of first locking member 44, or second locking member 46, when connector 22 is in the locked configuration, as described more fully herein.

Although the embodiment of screwdriver 10 shown in FIG. 2 includes a bar 28 that defines groups of multiple separate indentations 58, bar 28 can also define at least two indentations 58 (e.g., 2, 3, 4, 5, 6, 7, 8, 9, or 10 indentations 58) that are each in the form of a groove extending around the circumference of screwdriver bar body 56, and that are spaced at intervals along the length of screwdriver bar body 56.

Bar body 56 includes a first end 60 and a second end 62. In the embodiment of screwdriver bar 28 shown in FIG. 2, body 56 has a hexagonal configuration, but other polygonal configurations (e.g., triangular or square) are also useful. Screwdriver bar 28 also includes a first screwdriver head 64, located at bar body first end 60, and a second screwdriver head 66, located at bar body second end 62.

FIG. 3 shows a longitudinal cross-section of screwdriver handle 12 and connector body 30 showing the cavities therein. Connector body 30 defines connector cavity 36 that includes an anterior portion 68 and a posterior portion 70. Anterior portion 68 is narrower than posterior portion 70. Handle body 14 defines a handle cavity 72 that includes an anterior portion 74 and a posterior portion 76. Connector 22 is seated within handle cavity anterior portion 74.

FIG. 4 shows a longitudinal cross section of collar 26, seated around connector body 30, showing the disposition of various spaces defined by collar body 78 relative to connector body 30. To facilitate description of the aforementioned spaces, retaining spring 50, tensioning spring 48, first locking member 44 and second locking member 46 are not shown in FIG. 4. Collar 26 includes collar body 78 having an anterior end 80 and a posterior end 82. Body 78 defines a collar cavity 84, a first recessed space 86, a second recessed space 88, and a third recessed space 90. First recessed space 86 opens onto collar anterior end 80, and third recessed space 90 opens onto collar posterior end 82. Second recessed space 88 includes a first portion 92, a second portion 94 that is more deeply recessed than first portion 92, and an intermediate portion 96 disposed between first portion 92 and second portion 94. A collar body first portion 98 separates collar first recessed space 86 from collar second recessed space 88. A collar body second portion 100 separates collar second recessed space 88 from collar third recessed space 90.

Screwdriver 10 can be assembled, for example, by sliding hollow spacer 24 over connector body 30 so that spacer 24 is seated over connector body 30 and contacts handle second end 18. Tensioning spring 48 is then mounted on connector body 30 so that tensioning spring 48 is seated over and around connector body 30. Collar 26 is then mounted on connector body 30 so that connector body 30 penetrates collar cavity 84. Prior to seating collar 26 over connector body 30, first locking member 44 is introduced into first passage 38, and second locking member 46 is introduced into second passage 40. Collar 26 is pushed sufficiently far towards handle second end 18 that groove 42 is exposed. Retaining spring 50 is then seated within groove 42. Collar 26 may then be released so that collar 26 is biased against retaining spring 50 by the action of tensioning spring 48. Collar body first portion 98 engages retaining spring 50 and collar 26 is thereby retained on connector body 30.

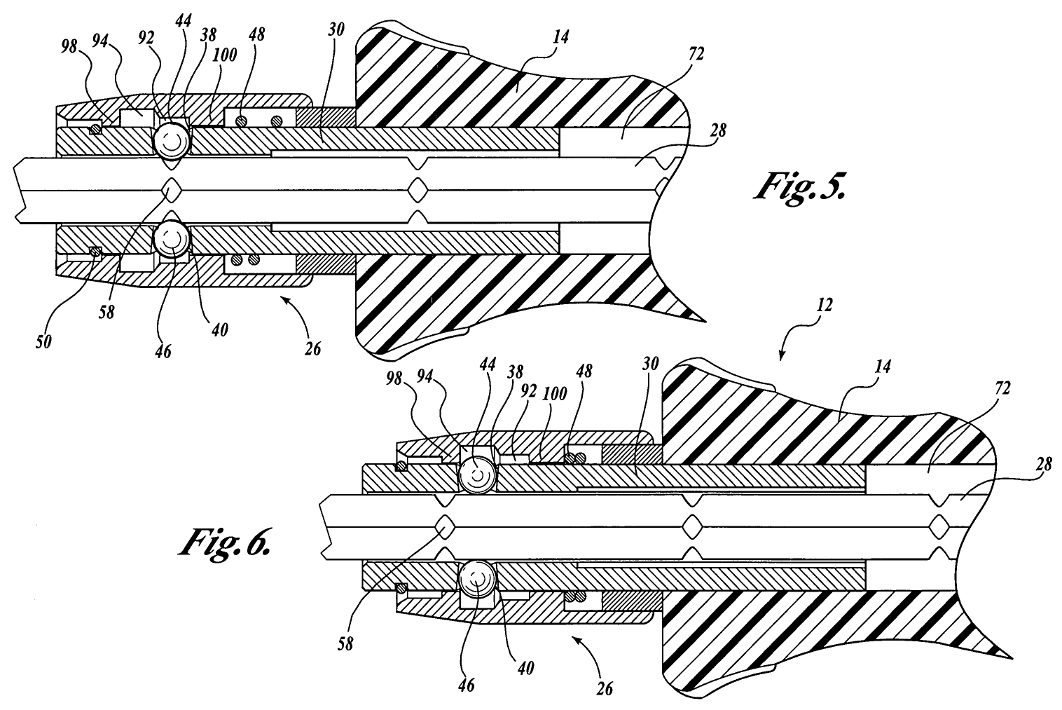

Connector 22 has a locked configuration and an unlocked configuration. FIG. 5 shows a longitudinal cross-section of connector 22 in the locked configuration. To facilitate description of the operation of connector 22, screwdriver bar 28 is shown disposed within connector cavity 36 and within handle cavity 72. As can be seen in FIG. 5, first locking member 44 is disposed within connector first passage 38, and second locking member 46 is disposed within connector second passage 40. Connector first passage 38 tapers towards connector cavity 36, and connector second passage 40 tapers towards connector cavity 36. The diameter of connector first passage 38 proximate to connector cavity 36 is less than the diameter of first locking member 44, thereby preventing first locking member 44 from passing through connector first passage 38 and completely entering connector cavity 36. Similarly, the diameter of connector second passage 40 proximate to connector cavity 36 is less than the diameter of second locking member 46, thereby preventing second locking member 46 from passing through connector second passage 40 and completely entering connector cavity 36.

In the locked configuration first locking member 44 and second locking member 46 each engage an indentation 58 of screwdriver bar 28, thereby completely or substantially immobilizing screwdriver bar 28 within connector cavity 36 and within handle cavity 72. In particular, first locking member 44 and second locking member 46 completely or substantially prevent screwdriver bar 28 from moving backwards or forwards within connector cavity 36 and handle cavity 72. Screwdriver bar 28 is further immobilized within connector cavity 36 by the physical interaction between screwdriver bar body 56 and connector body 30 defining anterior portion 68 of connector cavity 36.

In the locked configuration, first locking member 44 is physically constrained within connector first passage 38 and first portion 92 of collar second recessed space 88. Collar 26 is biased towards connector body first end 32 by the action of tensioning spring 48 pushing against second portion 100 of collar body 78. Collar 26 is retained on connector body 30 by retaining spring 50 that engages first portion 98 of collar body 78.

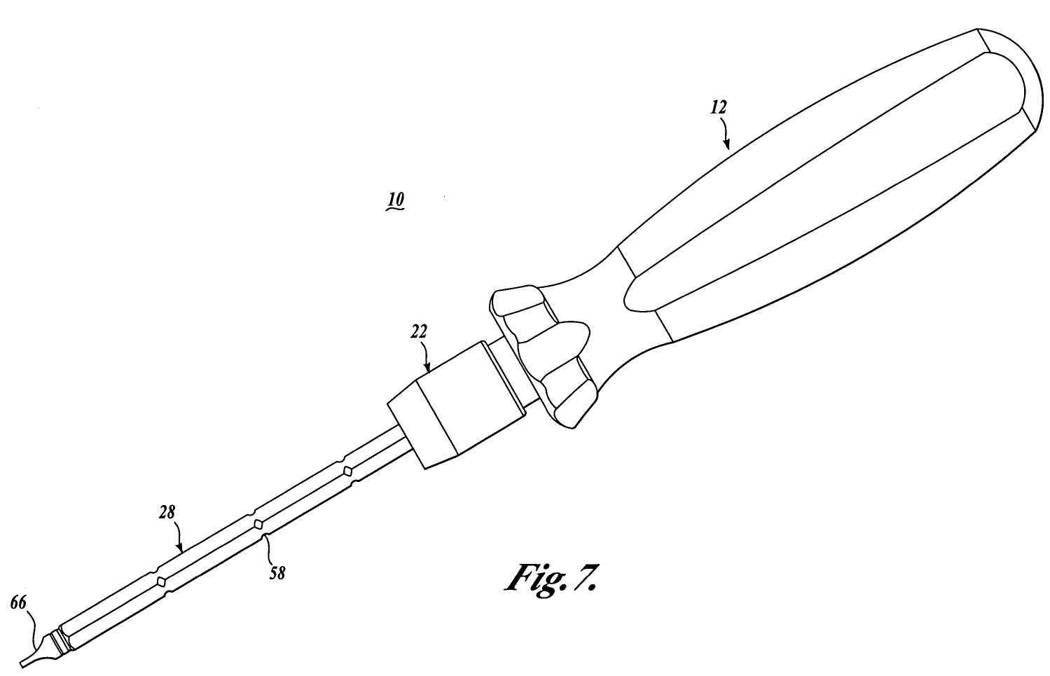

Screwdriver bar 28 can be removed from, or repositioned within, screwdriver 10 when connector 22 is in the unlocked configuration. For example, screwdriver bar 28 can be slid further into handle cavity 72 when connector 22 is in the unlocked configuration. FIG. 6 shows a longitudinal cross-section of connector 22 in the unlocked configuration. As shown in FIG. 6, collar 26 is displaced (e.g., manually pushed) towards screwdriver handle 12 so that second portion 94 of second recessed space 88 of collar 26 is located over connector first passage 38 and connector second passage 40, thereby permitting first locking member 44 and second locking member 46 to at least partially enter second portion 94 of second recessed space 88 of collar 26. First locking member 44 and second locking member 46 thereby disengage indentations 58 of screwdriver bar 28, permitting screwdriver bar 28 to be removed from screwdriver 10. If desired, while connector 22 is in the unlocked configuration a different screwdriver bar can be inserted into screwdriver 10.

The embodiments of screwdriver 10 shown in the FIGURES include first locking member 44 and second locking member 46; but embodiments of screwdriver 10 that include a single locking member (e.g., first locking member 44 or second locking member 46) are operable and are within the scope of the present invention. Also, embodiments of screwdriver 10 that include more than two locking members are also operable and are within the scope of the present invention.

It is an advantage of the present invention that the length of screwdriver bar 28 protruding from connector 22 can be varied by engaging different indentations 58 on screwdriver bar 28. For example, with respect to the embodiment of screwdriver 10 shown in FIG. 7, the length of screwdriver bar 28 protruding from connector 22 can be decreased by connector 22 engaging an indentation 58 located close to screwdriver head 66 (such as shown in the embodiment of screwdriver 10 shown in FIG. 1); and the length of screwdriver bar 28 protruding from connector 22 can be increased by connector 22 engaging an indentation 58 located farther from screwdriver head 66.

While the preferred embodiment of the invention has been illustrated and described, it will be appreciated that various changes can be made therein without departing from the spirit and scope of the invention.

1. A screwdriver comprising:
(a) a handle;
(b) a connector that is at least partially located within the handle; and
(c) a screwdriver bar comprising a bar body that defines a multiplicity of indentations, wherein in operation the connector releasably engages at least one of the indentations to secure the bar within the connector.

2. A screwdriver of claim 1 wherein at least part of the connector is disposed within a cavity that is defined by the handle.

3. A screwdriver of claim 1 wherein at least part of the screwdriver bar is disposed within the cavity that is defined by the handle.

4. A screwdriver of claim 1 wherein the connector comprises a connector body and a hollow collar that is slidably disposed around the connector body, wherein in operation actuation of the collar releases the screwdriver bar from the connector.

5. A screwdriver of claim 4 wherein the connector further comprises a retaining member disposed within the connector body that releasably engages the screwdriver bar.

6. A screwdriver of claim 4 wherein the connector comprises two retaining members, disposed within the connector body, that releasably engage the screwdriver bar.

7. A screwdriver of claim 6 wherein the connector has a locked configuration wherein the collar secures the retaining members against the screwdriver bar, and an unlocked configuration wherein the collar disengages the retaining members and the retaining members disengage the screwdriver bar.

8. A screwdriver of claim 1 wherein the screwdriver bar comprises a polygonal body.

9. A screwdriver of claim 8 wherein the body is hexagonal.

10. A screwdriver of claim 1 wherein the screwdriver bar comprises a body defining a multiplicity of indentations that are spaced along the length of the bar.

11. A screwdriver of claim 10 wherein the screwdriver bar body defines from two to six indentations that are spaced along the length of the bar.

12. A screwdriver of claim 10 wherein the screwdriver bar body defines five indentations that are spaced along the length of the bar.

13. A screwdriver of claim 1 wherein the screwdriver bar has a first end and a second end, and a screwdriver head is located at one of the first end and the second end.

14. A screwdriver of claim 1 wherein the screwdriver bar has a first end and a second end, and a first screwdriver head is located at the first end and a second screwdriver head is located at the second end.

15. A screwdriver of claim 14 wherein the screwdriver head located at the first end has a different configuration from the configuration of the screwdriver head located at the second end.

16. A screwdriver comprising:
(a) a handle defining a cavity;
(b) a connector that is at least partially located within the handle, wherein the connector comprises:
(1) a connector body that defines a central cavity, a first passage that completely penetrates the connector body, and a second passage that completely penetrates the connector body;
(2) a first retaining member disposed within the first passage;
(3) a second retaining member disposed within the second passage;
(4) a retaining spring disposed within a groove that extends around the connector body;
(5) a tensioning spring disposed around the connector body;
(6) a collar slidably disposed around the connector body, the retaining spring and the tensioning spring; and
(c) a screwdriver bar, defining a multiplicity of indentations, having a first end and a second end, wherein the second end is disposed within the screwdriver handle, wherein, in operation, the tensioning spring biases the collar against the retaining spring and against the first and second retaining members that engage at least one indentation in the screwdriver bar body, thereby securing the screwdriver bar within the screwdriver.
